(19) United States
(12) Patent Application Publication
(10) Pub. No.: US 2025/0186158 A1
(43) Pub. Date: Jun. 12, 2025

(54) Surgical Microscope System and System, Method and Computer Program for a Surgical Microscope System

(71) Applicant: Leica Instruments (Singapore) Pte Ltd., Singapore (SG)

(72) Inventor: George THEMELIS, Singapore (SG)

(21) Appl. No.: 18/844,443

(22) PCT Filed: Feb. 28, 2023
(86) PCT No.: PCT/EP2023/054989

§ 371 Date: Sep. 6, 2024

(30) Foreign Application Priority Data
Mar. 8, 2022 (DE) 102022105453.5

(51) Int. Cl. A61B 90/20; G06T 7/00

(52) U.S. Cl. CPC A61B 90/20; G06T 7/0012; G06T 2207/10056; G06T 2207/10121; G06T 2207/20081; G06T 2207/20182; G06T 2207/30101

(57) ABSTRACT

Examples relate to a surgical microscope system (100), and to a system (110), method, and computer system for a surgical microscope system. The system (110) is configured to obtain first imaging sensor data of a view on a surgical site from a first optical imaging sensor (122) of a microscope (120) of the surgical microscope system. The system is configured to obtain second imaging sensor data of the view on the surgical site from a second sensor (124) of the microscope. The system is configured to determine an extent of one or more anatomical features of the surgical site based on the second imaging sensor data. The system is configured to apply spatially varied noise filtering on the first imaging sensor data based on the extent of the one or more anatomical features of the surgical site.

### TECHNICAL FIELD

Examples relate to a surgical microscope system, and to a system, method, and computer system for a surgical microscope system.

### BACKGROUND

Digital microscopes, and in particular digital surgical microscopes, often have multiple imaging modes—such as a reflectance imaging mode, where the light being reflected by a sample being imaged is used to generate a digital view of the sample, and a fluorescence imaging mode, where fluorescence emissions being emitted by a fluorophore that is applied to the sample is used to generate the digital view of the sample.

Compared to the reflections being used in reflectance imaging, the fluorescence emissions have a substantially lower light intensity, so that the respective optical imaging sensors are usually operated at higher sensitivities. As result, fluorescence images often exhibit higher amounts of noise. While there are several methods for noise filtering, the noise filtering of fluorescence images remains a challenging topic, with the filtered images often being of suboptimal quality. In general, existing noise filtering methods are applied universally on the whole image.

A more effective filtering of the noise may improve the image quality and in particular increase the contrast.

### SUMMARY

There may be a desire for an improved concept for performing noise filtering on microscope images of lower-intensity light sources.

This desire is addressed by the subject-matter of the independent claims.

Various examples of the present disclosure are based on the finding, that different types of anatomical features can appear very differently in imaging sensor data generated by a digital surgical microscope. For example, in reflectance images of the brain, (blood) vessels can appear very distinctly, e.g., as red or purple features, while other types of tissue may be shown as lower-intensity flesh-colored background. Similarly, in fluorescence images of the brain, blood vessels that contain a fluorophore appear as relatively bright portions of the fluorescence image, while blood vessels that do not contain a fluorophore or other types of tissue remain dark. To improve the reduction of noise, these different portions of the respective images may be treated differently, so that the noise filtering being applied on the imaging sensor data is spatially varied. To improve the precision of the spatially varied noise filtering, imaging sensor data that clearly shows the extent and/or type of the respective features is used to determine the extent of the respective anatomical features being treated differently, with the actual spatially varied noise filter being applied to another set of imaging sensor data where the determination of the extent can be less precise or more difficult.

Various examples of the present disclosure relate to a system for a surgical microscope system. The system comprises one or more processors and one or more storage devices. The system is configured to obtain first imaging sensor data of a view on a surgical site from a first optical imaging sensor of a microscope of the surgical microscope system. The system is configured to obtain second imaging sensor data of the view on the surgical site from a second sensor of the microscope. The system is configured to determine an extent of one or more anatomical features of the surgical site based on the second imaging sensor data. The system is configured to apply spatially varied noise filtering on the first imaging sensor data based on the extent of the one or more anatomical features of the surgical site. By varying the spatially varied noise filtering based on the extent of the one or more anatomical features, the noise filtering may be tailored to the anatomical features being shown in the first and second imaging sensor data. By determining the extent of the one or more anatomical features using the second imaging sensor data, the precision of the determination of the extent may be increased.

For example, the first imaging sensor data may be based on fluorescence imaging. In this case, the spatially varied noise filtering may be particularly effective, as in portions of the imaging sensor data that do not show fluorescence emissions, a more aggressive noise filter can be used, while in portions of the imaging sensor data that show fluorescence emissions, a specialized noise filter can be used. Moreover, fluorescence imaging sensor data usually has low contrast, so that the determination of the extent of the one or more anatomical features can be improved if another set of imaging sensor data (i.e., the second imaging sensor data is used).

For example, the second imaging sensor data may be based on reflectance imaging. Alternatively, or additionally, other imaging techniques may be used, such as imaging spectroscopy including multispectral, hyperspectral and derivatives, reflectance and/or fluorescence, Raman imaging and derivatives, laser speckle imaging and derivatives, confocal image and derivatives, optical properties imaging, namely μₐ (absorption coefficient) and μₛ (scattering coefficient), ultrasound imaging, photoacoustic imaging and derivatives, 3D surface scanning, kinetics mapping imaging (e.g. Indo-Cyanine Green (ICG) bolus kinetics), functional imaging with any modality, pre-operative, or intra-operatively, prior or in real-time, or anatomical estimation imaging derived from comparison of tissue imaging in combination with anatomical databases. Various types of imaging may be suitable for determining the extent of anatomical features, depending on the type of anatomical feature and type of imaging modality available.

In general, not all anatomical features may be relevant with respect to the spatially varied filtering. For example, only some blood vessels might contain a fluorophore, while other blood vessels and other types of tissue might not light up in a fluorescence imaging. Therefore, a subset of the anatomical features (i.e., anatomical features of interest) may be selected from the determined one or more anatomical features. The system may be configured to determine at least one feature of interest among the one or more anatomical features of the surgical site, and to apply the spatially varied noise filtering based on the extent of the at least one feature of interest. For example, as outlined above, the one or more anatomical features may be one or more blood vessels, and the at least one feature of interest may be at least one blood vessel emitting fluorescence emissions.

Whether an anatomical feature is an anatomical feature of interest may be determined based on different criteria, e.g., based on a classification of the respective anatomical features. In some examples, the first imaging sensor data may be used to classify between anatomical features of interest and anatomical features that are not of interest. For example, the system may be configured to determine the at least one feature of interest among the one or more anatomical features based on the first imaging sensor data.

In some cases, whether an anatomical feature is an anatomical feature of interest might not be discernible in every frame of the first imaging sensor data. Therefore, multiple frames of the first imaging sensor data may be processed to determine whether an anatomical feature is of interest. For example, the system may be configured to determine the at least one feature of interest among the one or more anatomical features based on a plurality of frames of the first imaging sensor data covering a pre-defined time interval or two or more pre-defined points in time.

In many cases, it may suffice to apply two different types of noise filtering—a first type for the anatomical features (of interest) and a second type for the background (e.g., tissue that is of no or little interest in the surgical procedure). For example, the system may be configured to subdivide the first imaging sensor data in a first portion and in a second portion, the first portion being based on the extent of at least a subset of the one or more anatomical features of the surgical site. The system may be configured to apply a first noise filter on the first portion and a different second noise filter on the second portion.

For example, as outlined above, the first imaging sensor data may be subdivided into a first portion including the anatomical features (of interest) and a second portion including the rest, such as anatomical features that are not of interest and other types of tissue. For example, the system may be configured to subdivide the first imaging sensor data such, that the first portion comprises the extent of at least the subset of the one or more anatomical features of the surgical site and the second portion comprises the remainder of the first imaging sensor data.

In fluorescence imaging, some assumptions may be made with respect to the desired appearance of the anatomical feature(s) containing a fluorophore. One assumption is, that the intensity of the fluorescence emissions mostly adheres to a known intensity pattern. Accordingly, the first noise filter may be configured to apply a pre-defined intensity pattern on the first portion of the first imaging sensor data. In particular, the intensity pattern of the fluorescence emissions is mostly homogenous within the vessel. Accordingly, the pre-defined intensity pattern may be configured to apply a uniform intensity distribution on the first portion or on coherent sub-portions of the first portion. However, some gradual variation may be shown, e.g., a gradient along the longitudinal axis of the respective feature. For example, the predefined intensity pattern is configured to apply a uniform intensity distribution along a transversal axis of coherent sub-portions of the first portion and to apply an intensity gradient along a longitudinal axis of the coherent sub-portions of the first portion.

The proposed concept is particularly suitable for performing noise filtering on blood vessels. Blood vessels, in particular blood vessels of the brain, can be tree-like structures, with many branches. The distribution of fluorophores within the blood vessels may be influenced by the branches of the blood vessels. Accordingly, the blood vessels may be sub-divided into smaller sub-portions, and the noise filtering may be applied separately on the respective smaller subportions. For example, the system may be configured to subdivide the first portion into a plurality of coherent sub-portions based on the extent of at least the subset of the one or more anatomical features, and to apply the first noise filter separately on the coherent sub-portions. For example, the one or more anatomical features may be one or more blood vessels. The system may be configured to subdivide the first portion into a plurality of coherent sub-portions based on branching points of the one or more blood vessels. This may improve the quality of the noise filtering, as subtle gradients between the sub-portions can be modeled more precisely.

On the background or less important anatomical features, more coarse and/or aggressive noise filtering may be applied. For example, the second noise filter may be configured to apply a spatial low-pass filter on the second portion of the first imaging sensor data.

In general, at least two techniques may be used to determine the extent of the surgical site—a machine-learning-based approach, and a color/shape-based approach. For example, the system may be configured to determine the extent of one or more anatomical features of the surgical site using a machine-learning model being trained to perform image segmentation and/or object detection. Alternatively, or additionally, the system may be configured to determine the extent of the one or more anatomical features of the surgical site based on at least one of a characteristic color spectrum and a characteristic shape of the one or more anatomical features of the surgical site. Both techniques have advantages and disadvantages, e.g., with respect to computational effort, implementation complexity and/or traceability.

The result of the noise filtering may be displayed via a display device of the surgical microscope system. For example, the system may be configured to generate a display signal for a display device of the surgical microscope system based on at least the filtered first imaging sensor data. For example, the system may be configured to generate a composite digital view of the surgical site based on the filtered first imaging sensor data and based on the second imaging sensor data, and to generate the display signal based on the composite digital view. In other words, the first and second imaging sensor data may be combined in a single image and shown together on the display device.

Various examples of the present disclosure relate to a corresponding method for a surgical microscope system. The method comprises obtaining first imaging sensor data of a view on a surgical site from a first optical imaging sensor of a microscope of the surgical microscope system. The method comprises obtaining second imaging sensor data of the view on the surgical site from a second sensor of the microscope. The method comprises determining an extent of one or more anatomical features of the surgical site based on the second imaging sensor data. The method comprises applying spatially varied noise filtering on the first imaging sensor data based on the extent of the one or more anatomical features of the surgical site.

Various examples of the present disclosure relate to a corresponding computer program with a program code for performing the above method when the computer program is executed on a processor.

### SHORT DESCRIPTION OF THE FIGURES

Some examples of apparatuses and/or methods will be described in the following by way of example only, and with reference to the accompanying figures, in which

FIG. 1a shows a schematic diagram of an example of a system for a surgical microscope system;

FIG. 1b shows a schematic diagram of an example of a surgical microscope system;

FIG. 1c shows a schematic drawing of an example of a noisy fluorescence image of a surgical site;

FIG. 1d shows a schematic drawing of an example of a reflectance image of a surgical site;

FIG. 2 shows a flow chart of an example of a method for a surgical microscope system;

FIG. 3 shows a schematic diagram of noise filtering being applied on a noisy fluorescence image; and

FIG. 4 shows a schematic diagram of an example of a system comprising a microscope and a computer system.

### DETAILED DESCRIPTION

Various examples will now be described more fully with reference to the accompanying drawings in which some examples are illustrated. In the figures, the thicknesses of lines, layers and/or regions may be exaggerated for clarity.

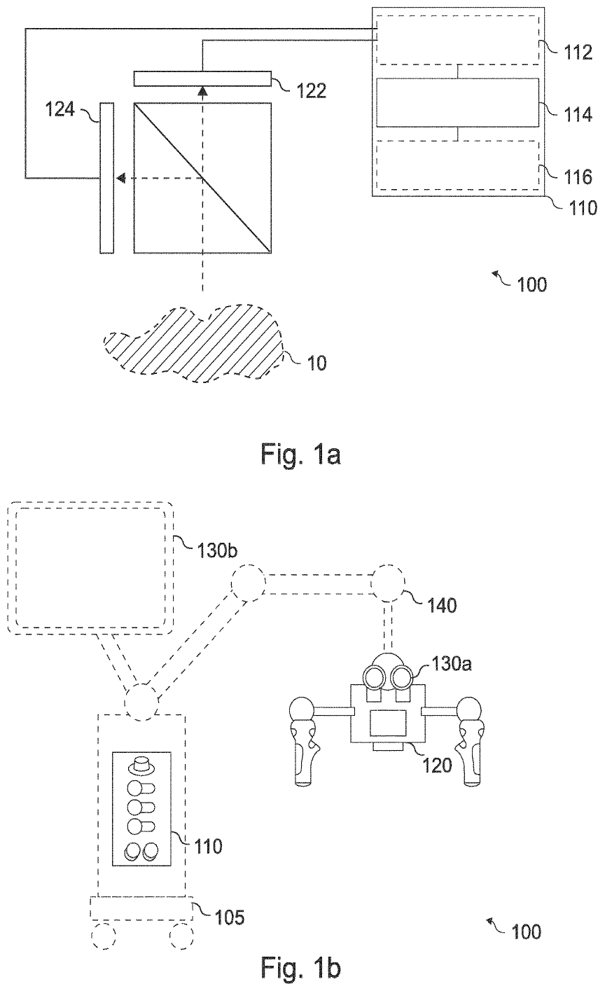

FIG. 1a shows a schematic diagram of an example of a system 110 for a surgical microscope system 110. The surgical microscope system 100 comprises the microscope 120, which is a digital microscope, i.e., it comprises at least one optical imaging sensor 122; 124, which is coupled with the system 110. In general, a microscope, such as the microscope 120, is an optical instrument that is suitable for examining objects that are too small to be examined by the human eye (alone). For example, a microscope may provide an optical magnification of a sample. In modern microscopes, the optical magnification is often provided for a camera or an imaging sensor, such as the first optical imaging sensor 122 and/or a second sensor 124 of the microscope 120. In FIG. 1a, the microscope 120 is shown with two optical imaging sensors 122; 124. However, the second sensor 124 need not necessarily be an optical imaging sensor but may be any kind of sensor capable of providing an image representation of the sample 10. The microscope 120 may further comprise one or more optical magnification components that are used to magnify a view on the sample, such as an objective (i.e., lens).

Beside the optical components that are part of the microscope 120, the surgical microscope system 100 further comprises the system 110, which is a computer system. The system 110 comprises one or more processors 114 and one or more storage devices 116. Optionally, the system further comprises one or more interfaces 112. The one or more processors 114 are coupled to the one or more storage devices 116 and to the optional one or more interfaces 112. In general, the functionality of the system is provided by the one or more processors 114, in conjunction with the one or more interfaces 112 (for exchanging information, e.g., with a first optical imaging sensor 122, with a second sensor 124, and/or with a display device, such as ocular displays 130a or an auxiliary display 130b), and/or with the one or more storage devices 116 (for storing and/or retrieving information).

The system 110 is configured to obtain first imaging sensor data of a view on a surgical site 10 from the first optical imaging sensor 122 of the microscope 120 of the surgical microscope system 100. The system 110 is configured to obtain second imaging sensor data of the view on the surgical site 10 from the second sensor 124 of the microscope 120. The system 110 is configured to determine an extent of one or more anatomical features of the surgical site based on the second imaging sensor data. The system 110 is configured to apply spatially varied noise filtering on the first imaging sensor data based on the extent of the one or more anatomical features of the surgical site. As is evident, the system 110 is a system for processing imaging sensor data in the surgical microscope system 100 and/or for controlling the microscope 120 and/or other components of the surgical microscope system 100.

In general, a microscope system, such as the surgical microscope system 100, is a system that comprises a microscope 120 and additional components, which are operated together with the microscope, such as the system 110 (which is a computer system being adapted to control the surgical microscope system, and, for example, process imaging sensor data of the microscope), and additional sensors, displays etc.

There are a variety of different types of microscopes. If the microscope is used in the medical or biological fields, the object 10 being viewed through the microscope may be a sample of organic tissue, e.g., arranged within a petri dish or present in a part of a body of a patient. In the present case, the microscope 120 is a microscope of a surgical microscope system, i.e., a microscope that is to be used during a surgical procedure, such as a neurosurgical procedure, an oncological surgical procedure or during tumor surgery. Accordingly, the object being viewed through the microscope may be a sample of organic tissue of a patient and may be in particular be the surgical site that the surgeon operates on during the surgical procedure. In the following, the object 10 to be imaged, i.e., the surgical site, is assumed to be a surgical site of a brain during the course of neurosurgery. However, the proposed concept is also suitable for other types of surgery, such as cardiac surgery or ophthalmology.

FIG. 1b shows a schematic diagram of an example of a surgical microscope system 100 comprising the system 110 and the microscope 120 (with the first optical imaging sensor 122 and with a second optical imaging sensor 124). The surgical microscope system 100 shown in FIG. 1b comprises a number of optional components, such as a base unit 105 (comprising the system 110) with a (rolling) stand, the ocular displays 130a that are arranged at the microscope 120, the auxiliary display 130b that is arranged at the base unit 105, and a (robotic or manual) arm 140 which holds the microscope 120 in place, and which is coupled to the base unit 105 and to the microscope 120. In general, these optional and non-optional components may be coupled to the system 110 which may be configured to control and/or interact with the respective components.

The proposed concept is based on processing two types of imaging sensor data—the first imaging sensor data, which is the imaging sensor data the spatially varied noise filtering is to be applied on, and the second imaging sensor data, which is the imaging sensor data being used to determine the extent of the one or more anatomical features. FIGS. 1c and 1d show two examples of such imaging sensor data. FIG. 1c shows a schematic drawing of an example of a noisy fluorescence image of a surgical site. In other words, the first imaging sensor data may be based on fluorescence imaging. Accordingly, the first optical imaging sensor may be an optical imaging sensor for performing fluorescence imaging. Alternatively, the first imaging sensor data may be based on other types of imaging that are based on sensing low light intensities. FIG. 1d shows a schematic drawing of an example of a corresponding reflectance image of the surgical site. In other words, the second imaging sensor data may be based on reflectance imaging. For example, the second imaging sensor data may be based on hyperspectral reflectance imaging. Accordingly, the second sensor may be an optical imaging sensor for performing reflecting imaging, e.g., hyperspectral reflectance imaging. For example, the first and second imaging sensor data may have the same field of view, or the field of view of the two sets of imaging sensor data may have a known spatial relationship. In FIG. 1d, the different anatomical features, two blood vessels 14; 16, are clearly distinguishable. Between the anatomical features 14; 16, tissue 12a; 12b; 12c is shown, which is considered to be “background” behind the anatomical features that are of interest. As is evident from the comparison between the figures, the blood vessels 14; 16 have different colors (visualized by two different line styles), due to different levels of oxygenation of the blood. Similarly, as shown in FIG. 1c, the fluorescence emissions emanating from of the two blood vessels have different intensities, due to the concentration of the fluorophore in the two blood vessels. Within a blood vessel, the intensity of the fluorescence emissions can be considered to be homogeneous, or at least homogeneous along the transversal axis, with a gradient along the longitudinal axis.

In the above example, the second imaging sensor data is based on reflectance imaging, e.g., hyperspectral reflectance imaging. However, different types of sensor imaging sensor data may be used. In this context, the term “second imaging sensor data” indicates, that the second imaging sensor data is obtained in image form, i.e., as an image. In general, the second imaging sensor data may be an image that is obtained from an optical imaging sensor, or an image that is derived from other types of optical or non-optical sensor data, or a computer-generated image that is derived from a pre-operative scan or database of anatomical features. For example, the second imaging sensor data may be based on or comprise at least one of imaging spectroscopy (including multispectral, hyperspectral and derivatives, reflectance and/or fluorescence), Raman imaging (and derivatives), laser speckle imaging (and derivatives), confocal imaging (and derivatives), an optical properties image (in particular an optical properties image representing μₐ (absorption coefficient) and/or μₛ (scattering coefficient) or derivatives thereof), ultrasound imaging, photoacoustic imaging (and derivatives), 3D surface scanning (e.g., using a depth sensor), kinetics mapping imaging (e.g. ICG bolus kinetics), a functional image captured with any modality (pre-operative, or intra-operatively, prior or in real-time), and an anatomical estimation image derived from comparison of tissue imaging in combination with anatomical data bases (e.g., showing where anatomical or functional tissue areas are located within the surgical site.) Accordingly, the second sensor may be one of an optical imaging sensor (such as a hyperspectral optical imaging sensor, a multispectral optical imaging sensor, an optical imaging sensor for fluorescence imaging (for kinetics imaging and/or imaging spectroscopy), a spectroscopic optical imaging sensor, a Raman spectroscopic optical imaging sensor, an optical imaging sensor for laser speckle imaging, confocal optical imaging sensors, or an optical imaging sensor for determine optical properties), an ultrasound sensor, a photoacoustic imaging sensor, and a depth sensor.

The second imaging sensor data is now used to determine the extent of the one or more anatomical features of the surgical site. To determine the extent of the one or more anatomical features, the one or more anatomical features may be determined (e.g., detected, identified) in the second imaging sensor data. For example, the second imaging sensor data may be analyzed to determine and distinguish the anatomical features in the imaging sensor data, e.g., blood vessels, tumors, branches, portions of tissue etc. In general, two types of techniques may be used to perform the determination of the extent.

In a first technique, a color-based and/or shape-based approach may be used. For example, the system may be configured to determine the extent of the one or more anatomical features of the surgical site based on at least one of a characteristic color spectrum and a characteristic shape of the one or more anatomical features of the surgical site. For example, each anatomical feature (of interest) may have a known characteristic color spectrum and/or characteristic shape. For example, depending on the oxygenation of the blood, blood vessels may have a color that is part of a known color spectrum being characteristic for blood vessels, ranging from bright red (for arterial blood) to bluish purple (for venous blood). For example, separate characteristic color spectra may be considered for blood vessels carrying arterial blood and blood vessels carrying venous blood. Moreover, blood vessels usually have a characteristic shape, with sharp edges that are discernible in the second imaging sensor data. The system may be configured to identify a portion (e.g., pixels) of the second imaging sensor data that have a color that is part of a characteristic spectrum of an anatomical feature (of interest) and/or that are part of a structure having a characteristic shape, and to determine the extent of the one or more anatomical features based on the portion (e.g., pixels) of the second imaging sensor data that have a color that is part of a characteristic spectrum of an anatomical feature (of interest) and/or that are part of a structure having a characteristic shape.

Alternatively (or additionally), as a second technique, machine-learning may be used to determine the extent of the one or more anatomical features. For this, one or both of the following machine-learning-based techniques may be used—image segmentation and object detection. In other words, the system may be configured to determine the extent of one or more anatomical features of the surgical site using a machine-learning model being trained to perform image segmentation and/or object detection. The system may be configured to perform image segmentation and/or object detection to determine the presence and/or location of the one or more anatomical features within the imaging sensor data. In object detection, the location of one or more pre-defined objects (i.e., objects that the respective machine-learning model is trained on) in imaging sensor data is output by a machine-learning model, along with a classification of the object (if the machine-learning model is trained to detect multiple different types of objects). In general, the location of the one or more pre-defined objects is provided as a bounding box, i.e., a set of positions forming a rectangular shape that surrounds the respective object being detected. In image segmentation, the location of features (i.e., portions of the second imaging sensor data that have similar attributes, e.g., that belong to the same object) are output by a machine-learning model. In general, the location of the features is provided as a pixel mask, i.e., the location of pixels that belong to a feature are output on a per-feature basis.

For both object detection and image segmentation, a machine-learning model is used that is trained to perform the respective task. For example, to train the machine-learning model being trained to perform object detection, a plurality or samples of imaging sensor data may be provided as training input samples, and a corresponding listing of bounding box coordinates may be provided as desired output of the training, with a supervised learning-based training algorithm being used to perform the training using the plurality of training input samples and corresponding desired output. For example, to train the machine-learning model being trained to perform image segmentation, the plurality or samples of imaging sensor data may be provided as training input samples, and corresponding pixel masks may be provided as desired output of the training, with a supervised learning-based training algorithm being used to perform the training using the plurality of training input samples and corresponding desired output. In some examples, the same machine-learning model may be used to perform both object detection and image segmentation. In this case, the two above-mentioned types of desired output may be used in parallel during the training, with the machine-learning model being trained to output both the bounding boxes and the pixel masks.

In general, both object detection and image segmentation may be used. The pixel mask(s) output by the image segmentation machine-learning model may be used to determine the extent of the one or more anatomical features, while the classification provided by the object detection may be used to determine whether an anatomical feature is of interest. Accordingly, at least one of the two techniques “object detection” and “image segmentation” may be used to analyze the second imaging sensor data and determine the anatomical features within the second imaging sensor data. For example, the system may be configured to perform image segmentation on the second imaging sensor data, and to determine the extent of the one or more anatomical features based on the pixel mask or pixel masks output by the image segmentation. Alternatively, or additionally, the system may be configured to perform object detection on the second imaging sensor data to identify at least one anatomical feature, and to determine feature or features of interest among the identified anatomical feature(s).

In some examples, the features being used to determine the one or more anatomical features (e.g., at least one feature of interest) may be restricted to specific groups of features. For example, the system may be configured to determine at least one feature of interest among the one or more anatomical features of the surgical site. For example, the system may be configured to perform the object detection to identify at least one of a blood vessel, branching points of a blood vessel, and a tumor within the second imaging sensor data as anatomical feature (of interest). Accordingly, the machine-learning model being trained to perform object detection may be trained to detect at least one of a blood vessel, branching points of a blood vessel and a tumor in imaging sensor data. Analogously, the machine-learning model being trained to perform image segmentation may be trained to perform image segmentation for at least one of a blood vessel, branching points of a blood vessel, and a tumor, in imaging sensor data. Accordingly, the one or more anatomical features (or feature(s) of interest) may be determined based on the output of one or more machine-learning models being trained to output information, such as bounding boxes or pixel masks, representing specific features, such as the aforementioned blood vessel, branching point, or tumor.

In various examples of the present disclosure, the first imaging sensor data is based on fluorescence imaging, with (only) anatomical features carrying a fluorophore (and thus emitting fluorescence emissions) being of interest with respect to the spatially varied noise filtering. In other words, the one or more anatomical features may be one or more blood vessels, or one or more other types of tissue (such as tissue of a tumor). Accordingly, the at least one feature of interest may be at least one blood vessel or other type of tissue emitting fluorescence emissions. To determine whether an anatomical feature, such as a blood vessel, is of interest, the determined extent of the anatomical feature may be cross-referenced with the first imaging sensor data, e.g., to determine a blood vessel or tissue that carry the fluorophore and thus is of interest with respect to the proposed noise filtering approach. In other words, the system may be configured to determine the at least one feature of interest among the one or more anatomical features based on the first imaging sensor data. For example, the system may be configured to compare the determined extent of the one or more anatomical features with the presence of fluorescence emissions in the first imaging sensor data, and to determine an anatomical feature to be of interest if fluorescence emissions (e.g., a sufficient quantity if fluorescence emissions) intersect with the extent of the respective anatomical feature.

In some cases, fluorescence emissions are not visible in every frame of the first imaging sensor data. Therefore, multiple frames of the first imaging sensor data may be used when determining whether an anatomical feature is of interest. For example, the system may be configured to determine the at least one feature of interest among the one or more anatomical features based on a plurality of frames of the first imaging sensor data covering a pre-defined time interval or two or more pre-defined points in time. For example, the pre-defined time interval may be a time-interval stretching into the past (relative to the time the determination is made), e.g., at least 5 seconds, or at least 10 seconds, or at least 30 second into the past. Similarly, the two or more pre-defined points in time may include the current point in time and a point in time in the past, e.g., a point in time at least 5 seconds, or at least 10 seconds, or at least 30 seconds in the past.

Once the one or more anatomical features, or the at least one feature of interest, are determined, they may be used as basis of the spatially varied noise filtering. In other words, the system is configured to apply the spatially varied noise filtering on the first imaging sensor data based on the extent of the one or more anatomical features of the surgical site, e.g., to apply the spatially varied noise filtering based on the extent of the at least one feature of interest. In effect, the first imaging sensor data may be sub-divided into different portions, with different noise filtering being applied to the different portions. For example, the pixels of the first imaging sensor data may be assigned to one of the two or more different portions. The noise filtering may be applied on the respective pixels based on which portion the respective pixel is assigned to.

In a basic example, two different portions are used—a first portion that includes the at least one feature of interest (or the one or more anatomical features, if the concept of features of interest is not used), and a second portion that contains the remainder of the first imaging sensor data. In other words, the system may be configured to subdivide the first imaging sensor data in the first portion and in the second portion. The first portion may be based on the extent of at least a subset of the one or more anatomical features of the surgical site (e.g., based on the extent of the at least one feature of interest). For example, the first portion may comprise the extent of at least the subset of the one or more anatomical features of the surgical site (e.g., the extent of the at least one feature of interest). The second portion may comprise the remainder of the first imaging sensor data. For example, pixels that are part of the extent of at least the subset of the one or more anatomical features of the surgical site, e.g., that are part of the at least one feature of interest, may be assigned to the first portion, and the remainder of the pixels may be assigned to the second portion. Among the first portion, pixels may be assigned to different coherent sub-portions (as will become evident in the following). The system may be configured to apply a first noise filter on the first portion and a different second noise filter on the second portion. In other words, the noise filtering may vary between the first portion and the second portion, i.e., the noise filtering being applied on the first portion may be different from the noise filtering being applied on the second portion.

The second portion may be considered of less interest to the surgeon, as it may be regarded as “background”, while the at least one feature of interest defining the first portion may be regarded as “foreground”. In general, the second portion, i.e., the background, may be expected to be mostly static and to contain mostly soft transitions between different types of tissue (due to the composition of the background and/or due to being out of focus). Therefore, a spatial low-pass filter may be applied on the second portion of the first imaging sensor data. In other words, the second noise filter may be configured to apply a spatial low-pass filter on the second portion of the first imaging sensor data. For example, a 2D Fourier transform may be used to convert the respective pixels into the frequency space, where the spatial low-pass filter may be applied.

In various examples of the present disclosure, the first imaging sensor data is assumed to be based on fluorescence imaging. As discussed in connection with FIG. 1c, fluorescence images tend to have a homogeneous intensity profile within the respective blood vessels, with little or no variation along the transversal axis (e.g., the axis orthogonal to the flow of blood) and with a gradient along the longitudinal axis (e.g., the axis along the flow of blood). Similar assumptions may be made with respect to other types of first imaging sensor data, such that a known intensity pattern can be assumed in many cases. Such a known intensity pattern can be used to define the noise filter being used for the first portion. For example, the first noise filter may be configured to apply a pre-defined intensity pattern on the first portion of the first imaging sensor data. For example, the pre-defined intensity pattern may be characteristic for the anatomical feature(s) (of interest) being included in the first portion.

In general, a microscope has a small field of view due to the magnification it provides. Within this field of view, in a basic approximation, the intensity of fluorescence emissions being emitted by the fluorophores present in a blood vessel may be considered to be uniform across the blood vessel. Accordingly, the pre-defined intensity pattern may be configured to apply a uniform intensity distribution on the first portion or on coherent sub-portions of the first portion. For example, the uniform intensity distribution (i.e., the same intensity) may be applied to the entire first portion. Alternatively, on each anatomical feature (of interest), a separate uniform intensity distribution may be applied. Additionally, separate uniform intensity distributions may be applied on portions of the anatomical features. Alternatively, the pre-defined intensity pattern may be configured to apply a uniform intensity distribution along a transversal axis of the coherent sub-portions of the first portion and to apply an intensity gradient along a longitudinal axis of the coherent sub-portions of the first portion. Depending on the granularity being used, the first filter may be applied on the entire first portion or onto the coherent sub-portions of the first portion. Accordingly, if a finer granularity is used, the first portion may be sub-divided into coherent sub-portions. In other words, the system may be configured to subdivide the first portion into a plurality of coherent sub-portions based on the extent of at least the subset of the one or more anatomical features. Such a sub-division is illustrated with respect to FIG. 1d. While FIG. 1d represents the second imaging sensor data, it is used to illustrate the concept, as the coherent sub-portions can be delimited more clearly in FIG. 1d.

As outlined above, different granularity levels of coherent sub-portions may be used. For example, each blood vessel may be considered to be a separate coherent sub-portion. For example, the blood vessel 14 may be considered a coherent sub-portion and the blood vessel 16 may be considered to be another coherent sub-portion. Since blood vessels are often interconnected structures with many branches, a finer granularity may be chosen for the sub-division.

For example, coherent sub-portions of a blood vessels may be defined by the branching points of the blood vessels. For example, the blood vessel 14 may be sub-divided into coherent subportions 14a; 14b and 14c at the branching point between sub-portion 14a and sub-portions 14b and 14c. In other words, the system may be configured to subdivide the first portion into a plurality of coherent sub-portions based on branching points of the one or more blood vessels. Depending on the granularity chosen, the first filter may be applied separately on the respective sub-portions. For example, the first filter may be applied separately on each blood vessel or applied separately on each coherent sub-portion of a blood vessel. In effect, the system may be configured to apply the first noise filter separately on the coherent sub-portions.

Depending on which type of pre-defined intensity distribution is used, different measurements may be used as reference for determining the intensity reference of the respective pre-defined intensity distribution. For example, the system may be configured to determine an average or median intensity of the pixels of the first imaging sensor data belonging to the first portion or coherent sub-portion of the first portion, and to determine the intensity of the uniform intensity distribution based on the average or median intensity of the pixels belonging to the first portion or coherent sub-portion of the first portion. In case a gradient along the longitudinal axis is used, the intensity of the pixels at the respective ends of the blood vessel or coherent sub-portion of the blood vessel may be determined, and the intensity values of the gradient may be determined based on the intensity of the pixels at the respective ends of the blood vessel or coherent sub-portion of the blood vessel.

The result of the de-noising may be shown on a display device of the surgical microscope system, e.g., the ocular displays 130a and/or the auxiliary display 130b. For example, the system may be configured to generate a display signal for a display device 130 of the surgical microscope system based on at least the filtered first imaging sensor data. For example, the system may be configured to generate a digital view of the surgical site (only) based on the filtered first imaging sensor data, e.g., a digital view where the fluorescence emissions are shown in isolation. Alternatively, the system may be configured to generate a digital view of the surgical site based on the filtered first imaging sensor data and based on (filtered or unfiltered) second imaging sensor data, e.g., a composite digital view. For example, the system may be configured to generate a composite digital view of the surgical site based on the filtered first imaging sensor data and based on the second imaging sensor data. For example, the fluorescence emission may be included as pseudocolor representation in the composite digital view (e.g., using a single color that stands out vis-à-vis the second imaging sensor data). The system may be configured to generate the display signal based on the digital view, e.g., based on the composite digital view. For example, the display signal may be a signal for driving (e.g., controlling) the display device 130. For example, the display signal may comprise video data and/or control instructions for driving the display. For example, the display signal may be provided via one of the one or more interfaces 112 of the system. Accordingly, the system 110 may comprise a video interface 112 that is suitable for providing the display signal to the display 130 of the microscope system 100.

In the proposed microscope system, at least one optical imaging sensor is used to provide the imaging sensor data. Accordingly, the first optical imaging sensor 122 is configured to generate the first imaging sensor data. Optionally, a second optical imaging sensor 124 or another type of sensor may be configured to generate the second imaging sensor data. For example, the optical imaging sensor(s) 122; 124 of the microscope 120 may comprise or be an APS (Active Pixel Sensor)—or a CCD (Charge-Coupled-Device)-based imaging sensor(s). For example, in APS-based imaging sensors, light is recorded at each pixel using a photodetector and an active amplifier of the pixel. APS-based imaging sensors are often based on CMOS (Complementary Metal-Oxide-Semiconductor) or S-CMOS (Scientific CMOS) technology.

In CCD-based imaging sensors, incoming photons are converted into electron charges at a semiconductor-oxide interface, which are subsequently moved between capacitive bins in the imaging sensors by a circuitry of the imaging sensors to perform the imaging. The processing system 110 may be configured to obtain (i.e., receive or read out) the respective imaging sensor data from the respective sensor 122; 124. The imaging sensor data may be obtained by receiving the imaging sensor data from the respective sensor (e.g., via the interface 112), by reading the imaging sensor data out from a memory of the respective sensor (e.g., via the interface 112), or by reading the imaging sensor data from a storage device 116 of the system 110, e.g., after the imaging sensor data has been written to the storage device 116 by the sensor or by another system or processor.

The one or more interfaces 112 of the system 110 may correspond to one or more inputs and/or outputs for receiving and/or transmitting information, which may be in digital (bit) values according to a specified code, within a module, between modules or between modules of different entities. For example, the one or more interfaces 112 may comprise interface circuitry configured to receive and/or transmit information. The one or more processors 114 of the system 110 may be implemented using one or more processing units, one or more processing devices, any means for processing, such as a processor, a computer or a programmable hardware component being operable with accordingly adapted software. In other words, the described function of the one or more processors 114 may as well be implemented in software, which is then executed on one or more programmable hardware components. Such hardware components may comprise a general-purpose processor, a Digital Signal Processor (DSP), a micro-controller, etc. The one or more storage devices 116 of the system 110 may comprise at least one element of the group of a computer readable storage medium, such as a magnetic or optical storage medium, e.g., a hard disk drive, a flash memory, FloppyDisk, Random Access Memory (RAM), Programmable Read Only Memory (PROM), Erasable Programmable Read Only Memory (EPROM), an Electronically Erasable Programmable Read Only Memory (EEPROM), or a network storage.

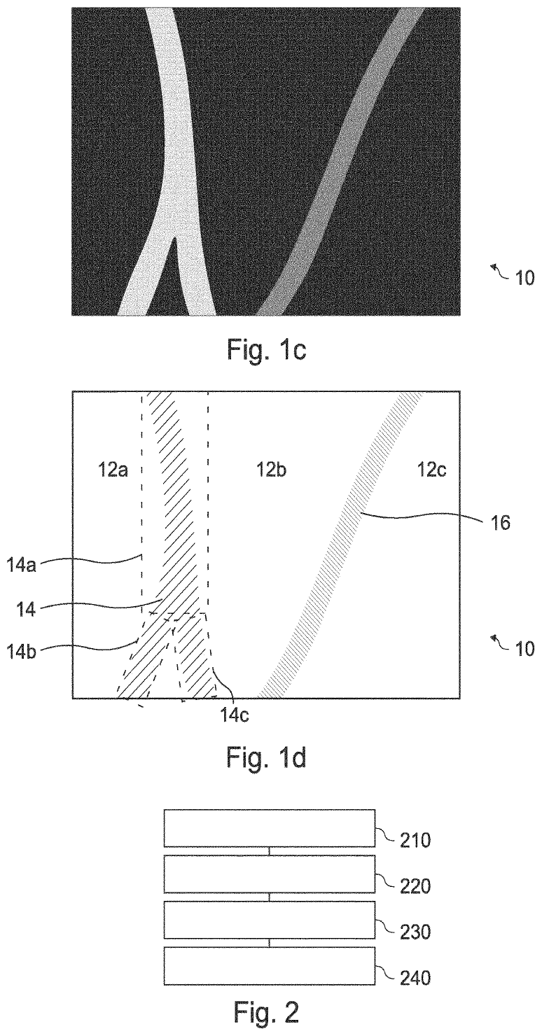

More details and aspects of the system and surgical microscope system are mentioned in connection with the proposed concept, or one or more examples described above or below (e.g., FIG. 2 to 4). The system and surgical microscope system may comprise one or more additional optional features corresponding to one or more aspects of the proposed concept, or one or more examples described above or below.

FIG. 2 shows a flow chart of an example of a corresponding method for a surgical microscope system. For example, the method may be performed by the system and/or surgical microscope system shown in connection with FIGS. 1a to 1d. The method comprises obtaining 210 first imaging sensor data of a view on a surgical site from a first optical imaging sensor of a microscope of the surgical microscope system. The method comprises obtaining 220 second imaging sensor data of the view on the surgical site from a second sensor of the microscope.

The method comprises determining 230 an extent of one or more anatomical features of the surgical site based on the second imaging sensor data. The method comprises applying 240 spatially varied noise filtering on the first imaging sensor data based on the extent of the one or more anatomical features of the surgical site.

For example, features introduced into the system and/or surgical microscope system of FIGS. 1a to 1d may be likewise introduced into the corresponding method of FIG. 2.

More details and aspects of the method are mentioned in connection with the proposed concept, or one or more examples described above or below (e.g., FIG. 1a to 1d, 3 to 4). The method may comprise one or more additional optional features corresponding to one or more aspects of the proposed concept, or one or more examples described above or below. Various examples of the present disclosure relate to a concept for spatially selective (i.e., spatially varied) noise filtering, e.g., on fluorescence images using information gathered from white-light images. In short, the proposed concept may relate to selective noise filtering.

In particular, the proposed concept may be used to filter noise from a fluorescence image, using the information from the white light image. By evaluating the white light image, the fluorescence image may be sub-divided into a background portion and a fluorescence area portion. In effect, different filters may be applied on the different portions of the image. For example, a high pass filter may be applied on the background and a low pass filter may be applied on the fluorescence area. This may result in improved image quality of the fluorescence image, through the reduction of noise on the fluorescence image.

In particular, with some fluorescence imaging modes, it is known that the fluorescence emissions are limited to the vessels—accordingly, an (aggressive) filter may be applied to reduce the noise in the background. Noise filtering can be made more efficient when additional information about the imaging sensor data is available. For example, if an image can be segmented into areas with homogenous fluorescence intensity (e.g., coherent sub-portions), it may be more efficient to filter each segment separately, while maintaining the sharpness of the segment borders. In more complex cases, when the intensity within a segment is known to follow a specific pattern, it is possible to fit/filter the signal. In effect, the proposed concept is based on using additional information for the filtering process, with the additional information being extracted from the white light image captured simultaneously, or any other images. Moreover, prior knowledge about the expected spatial pattern of the fluorescence signal may be used for a more effective filtering process.

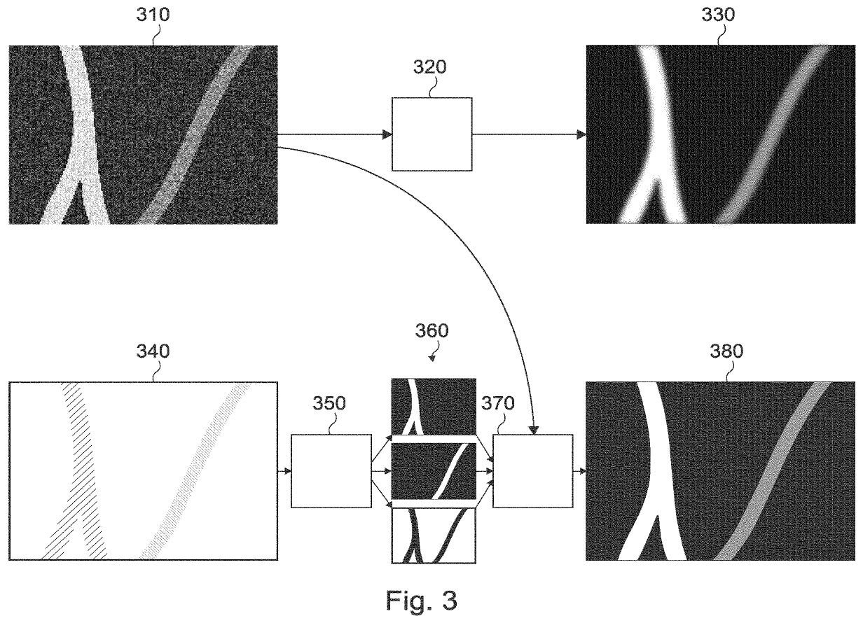

FIG. 3 shows a schematic diagram of noise filtering being applied on a noisy fluorescence image 310 (e.g., first imaging sensor data). In some systems, a universal noise filter 320 is applied to the noisy fluorescence image, leading to a blurry filtered image 330, i.e., a filtered image with low contrast and soft edges. In the proposed concept, a white light image 340 (e.g., second imaging sensor data) is segmented 350 into different portions 360 (e.g., coherent sub-portions), and a segment-wise noise-filter 370 is applied, resulting in a higher-contrast filtered image 380 with sharper edges.

For example, ICG (Indo-Cyanine Green) is typically used for imaging of the blood vessels. The fluorescence intensity within each vessel can be considered as constant within the vessel, while the shape of the vessel can be extracted from the white light image. A simple filtering model may be implemented by calculating the mean fluorescence intensity within the vessel and assigning the value to all vessel pixels. A more complex model may assume a smooth variation (e.g., gradient) along the length (longitudinal axis) of the vessel while constant along the width (transversal axis). In that case, a 2D-fitting model may be applied to assign values within the vessel pixels.

For the background tissue, it might not be possible to assume a constant value for all pixels, but it may be assumed that high spatial frequencies are not present due to the typical smooth appearance of the tissue without sharp borders. Accordingly, a spatial low-pass filter may be applied. Such spatially selective/varied filtering model may lead to substantial increase in sensitivity, as the fluorescence value may be calculated from hundreds or thousands of pixels. As a result, it may be possible to detect effectively signals one or two orders of magnitude weaker than with the unfiltered image. As a result, it may become possible to administer 1/10 or 1/100 of the fluorophore dose.

A more generic implementation of the proposed concept relates to the analysis of the white light image to calculate the 2D spatial spectrum which represent the anatomical characteristics of the tissue, and therefore gain knowledge about the spatial patters that are not expected to appear in a fluorescence image and conversely the spatial patterns that could potentially appear at the fluorescence image.

The spatially selective filtering concept may relate to image enhancement, e.g., for use in microsurgery (Vascular & Oncology). It may be based on the use of software and/or machine-learning.

More details and aspects of the concept for spatially selective noise filtering are mentioned in connection with the proposed concept or one or more examples described above or below (e.g., FIG. 1a to 2). The concept for spatially selective noise filtering may comprise one or more additional optional features corresponding to one or more aspects of the proposed concept, or one or more examples described above or below.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

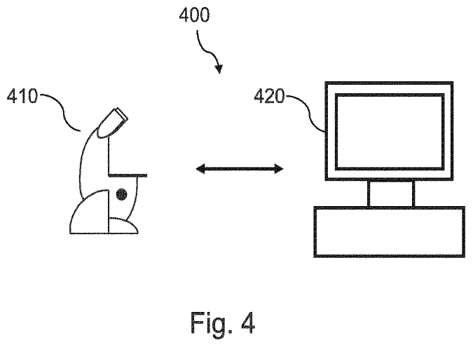

Some embodiments relate to a microscope comprising a system as described in connection with one or more of the FIGS. 1 to 3. Alternatively, a microscope may be part of or connected to a system as described in connection with one or more of the FIGS. 1 to 3. FIG. 4 shows a schematic illustration of a system 400 configured to perform a method described herein. The system 400 comprises a microscope 410 and a computer system 420. The microscope 410 is configured to take images and is connected to the computer system 420. The computer system 420 is configured to execute at least a part of a method described herein. The computer system 420 may be configured to execute a machine learning algorithm. The computer system 420 and microscope 410 may be separate entities but can also be integrated together in one common housing. The computer system 420 may be part of a central processing system of the microscope 410 and/or the computer system 420 may be part of a subcomponent of the microscope 410, such as a sensor, an actor, a camera or an illumination unit, etc. of the microscope 410.

The computer system 420 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 420 may comprise any circuit or combination of circuits. In one embodiment, the computer system 420 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 420 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 420 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 420 may also include a display device, one or more speakers, and a keyboard and/or controller, which can include a mouse, trackball, touch screen, voice-recognition device, or any other device that permits a system user to input information into and receive information from the computer system 420.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a nontransitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

### LIST OF REFERENCE SIGNS

10 Sample, surgical site
12 Background tissue
14, 16 Blood vessels
14a, 14b, 14c Coherent sub-portions of a blood vessel
100 Surgical microscope system
105 Base unit
110 System
112 Interface
114 Processor
116 Storage device
120 Microscope
122 Optical imaging sensor
124 Sensor, optical imaging sensor
130a Ocular displays
130b Auxiliary display
140 Arm
210 Obtaining first imaging sensor data
220 Obtaining second imaging sensor data
230 Determining an extent of one or more anatomical features
240 Applying spatially varied noise filtering
310 Noisy fluorescence image
320 Universal noise filter
330 Blurry filtered image
340 White light image
350 Segmentation
360 Segmented portions
370 Segment-wise noise filter
380 Filtered image
400 System
410 Microscope
420 Computer system

1. A system for a surgical microscope system (100; 400), the system comprising one or more processors and one or more storage devices, wherein the system is configured to:
obtain first imaging sensor data of a view on a surgical site from a first optical imaging sensor of a microscope (120; 410) of the surgical microscope system;
obtain second imaging sensor data of the view on the surgical site from a second sensor of the microscope;
determine an extent of one or more anatomical features of the surgical site based on the second imaging sensor data;
apply spatially varied noise filtering on the first imaging sensor data based on the extent of the one or more anatomical features of the surgical site.

2. The system according to claim 1, wherein the first imaging sensor data is based on fluorescence imaging.

3. The system according to claim 1, wherein the second imaging sensor data is based on reflectance imaging.

4. The system according to claim 1, wherein the system is configured to determine at least one feature of interest among the one or more anatomical features of the surgical site, and to apply the spatially varied noise filtering based on the extent of the at least one feature of interest.

5. The system according to claim 4, wherein the one or more anatomical features are one or more blood vessels, wherein the at least one feature of interest is at least one blood vessel emitting fluorescence emissions.

6. The system according to claim 4, wherein the system is configured to determine the at least one feature of interest among the one or more anatomical features based on the first imaging sensor data.

7. The system according to claim 4, wherein the system is configured to determine the at least one feature of interest among the one or more anatomical features based on a plurality of frames of the first imaging sensor data covering a pre-defined time interval or two or more pre-defined points in time.

8. The system according to claim 1, wherein the system is configured to subdivide the first imaging sensor data in a first portion and in a second portion, the first portion being based on the extent of at least a subset of the one or more anatomical features of the surgical site, and to apply a first noise filter on the first portion and a different second noise filter on the second portion.

9. The system according to claim 8, wherein the system is configured to subdivide the first imaging sensor data such, that the first portion comprises the extent of at least the subset of the one or more anatomical features of the surgical site and the second portion comprises the remainder of the first imaging sensor data.

10. The system according to claim 8, wherein the first noise filter is configured to apply a pre-defined intensity pattern on the first portion of the first imaging sensor data.

11. The system according to claim 10, wherein the pre-defined intensity pattern is configured to apply a uniform intensity distribution on the first portion or on coherent sub-portions of the first portion,
or wherein the pre-defined intensity pattern is configured to apply a uniform intensity distribution along a transversal axis of coherent sub-portions of the first portion and to apply an intensity gradient along a longitudinal axis of the coherent sub-portions of the first portion.

12. The system according to claim 8, wherein the system is configured to subdivide the first portion into a plurality of coherent sub-portions based on the extent of at least the subset of the one or more anatomical features, and to apply the first noise filter separately on the coherent sub-portions.

13. The system according to claim 12, wherein the one or more anatomical features are one or more blood vessels, wherein the system is configured to subdivide the first portion into a plurality of coherent sub-portions based on branching points of the one or more blood vessels.

14. The system according to claim 8, wherein the second noise filter is configured to apply a spatial low-pass filter on the second portion of the first imaging sensor data.

15. The system according to claim 1, wherein the system is configured to determine the extent of one or more anatomical features of the surgical site using a machine-learning model being trained to perform image segmentation and/or object detection.

16. The system according to claim 1, wherein the system is configured to determine the extent of the one or more anatomical features of the surgical site based on at least one of a characteristic color spectrum and a characteristic shape of the one or more anatomical features of the surgical site.

17. The system according to claim 1, wherein the system is configured to generate a display signal for a display device of the surgical microscope system based on at least the filtered first imaging sensor data.

18. The system according to claim 17, wherein the system is configured to generate a composite digital view of the surgical site based on the filtered first imaging sensor data and based on the second imaging sensor data, and to generate the display signal based on the composite digital view.

19. A method for a surgical microscope system, the method comprising:
obtaining first imaging sensor data of a view on a surgical site from a first optical imaging sensor of a microscope of the surgical microscope system;
obtaining second imaging sensor data of the view on the surgical site from a second sensor of the microscope;
determining an extent of one or more anatomical features of the surgical site based on the second imaging sensor data;
applying spatially varied noise filtering on the first imaging sensor data based on the extent of the one or more anatomical features of the surgical site.

20. A non-transitory, computer-readable medium comprising a program code that, when the program code is executed on a processor, a computer, or a programmable hardware component, causes the processor, computer, or programmable hardware component to perform the method according to claim 19.
